(19) United States
(12) Patent Application Publication
(10) Pub. No.: US 2010/0290707 A1
(43) Pub. Date: Nov. 18, 2010

(54) IMAGE ACQUISITION METHOD, DEVICE AND RADIOGRAPHY SYSTEM

(76) Inventors: Dejun Wang, Beijing (CN); Huanzhong Li, Beijing (CN); Tiantian Zhang, Waukesha, WI (US); Xianfeng Ni, Sussex, WI (US); Kadri Jabri, Oak Creek, WI (US)

Correspondence Address: PATRICK W. RASCHE (20459);ARMSTRONG TEASDALE LLP, 7700 Forsyth Boulevard, Suite 1800, St. Louis, MO, 63105, US

(21) Appl. No.: 12/777,414

(22) Filed: May 11, 2010

(30) Foreign Application Priority Data
May 12, 2009 (CN) 200910141210.1

(51) Int. Cl. G06K 9/46; G01N 23/04

(52) U.S. Cl. 382/190; 378/62

(57) ABSTRACT

An image acquisition method includes determining the starting position, the ending position of a region of interest, and the value of overlap of the region of interest in the two adjacent sub-images, calculating the number of the sub-images required to be captured, the component of field of view at the direction of tube movement and the positions of the tube and the detector corresponding to each sub-image based on the starting position and the ending position of a region of interest and the value of the overlap. The method also includes moving the tube and the detector to each position and capturing the region of interest to obtain sub-images at the positions, and pasting the several sub-images together to form an image of the said region of interest.

### CROSS REFERENCE TO RELATED APPLICATIONS

This application claims the benefit of Chinese Patent Application No. 200910141210.1 filed May 12, 2009, which is hereby incorporated by reference in its entirety.

### BACKGROUND OF THE INVENTION

Embodiments of the present invention generally relate to the field of medical digital radiography systems and, particularly, to an image acquisition method, device and a radiography system.

In the medical field, a radiography system is generally used. For example, an X-ray machine is used for imaging a region of interest of a patient, and the doctor then conducts the diagnosis and treatment on the patient according to the obtained images. FIG. 1 shows an X-ray machine, and the main parts thereof include an X-ray tube 1, an X-ray collimator 2, a patient securing device 3, a detector 4, wherein the main function of the X-ray tube 1 is to emit X-ray; the main function of the X-ray collimator 2 is to limit the radiation range of light field of X-ray emitted by the X-ray tube 1; the function of the detector 4 lies in receiving X-ray and imaging and then transmitting to a workstation for further processing; the function of the patient securing device 3 lies in two points: the first point is to isolate a patient from the detector 4 for safety, and the second point is to fix a patient so as to minimize the movements of the patient in the whole process of capturing.

As known from said X-ray machine, the tube 1 emits X-ray through a region of interest, which then comes to the X-ray detector 4 so that the image of the region of interest is acquired. The size of the obtained image is generally equal to the size of the X-ray detector. If the field of view of a region of interest is within the size of the X-ray detector, the entire region of interest can be completely presented in one image. For example, the fields of view of regions of interest such as heart, lung and the like are within the size of X-ray detector, so the regions of interest such as heart, lung and the like can be fully shown in an image. Then for some regions of interest, the fields of view of which are larger than the size of the X-ray detector, such as spine, thigh, etc., one image cannot present the entire regions of interest. Such cases need the capturing of a plurality of sub-images, and then pasting these sub-images together to form a complete image that can show the entire region of interest.

At present, for the regions of interest whose fields of view are larger than the X-ray detector size, several methods are used for imaging, falling into two main categories: one category is angulated acquisition method, including capturing multiple sub-images of a region of interest by angulating a tube, i.e. changing the angles of a tube. In other words, capturing a sub-image related to a region of interest when the tube is at a certain angle, and then capturing a sub-image related to the region of interest when the tube is changed to another angle, and so on, till the region of interest is completely covered in all sub-images. Finally, pasting all the sub-images together to form an image of the region of interest. For example, the U.S. Pat. No. 7,177,455, which is assigned to the assignee of the present invention, adopts the method of angulating the tubes to acquire a image of a region of interest.

Firstly, due to the need of angulating the tube, a tube angulating positioner is applied. Said tube angulating positioner is very expensive, so the costs of the machines with the use of said method are great.

Secondly, the first sub-image and the second sub-image have an overlap. As shown in FIG. 2, a tube moves on a parallel movement plane 14 of the tube and emits X-ray to irradiate patients. The detector is disposed on a detector incident plane 12. Although the first sub-image and the second sub-image overlap, a region of interest 10 on the plane of the region of interest does not have an overlap, and a part 10 on the region of interest 10 is not included in any sub-image, so the finally acquired image of the region of interest is inaccurate.

The other category is a method of the parallel movement of a tube and an X-ray detector. That is, capturing a sub-image when the tube and the X-ray detector are at a first position, and then simultaneously moving the tube and the X-ray detector in parallel to a second position, and then capturing a sub-image, and so on and so forth, parallelly moving the tube and the X-ray detector in sequence till the end of the region of interest and finally paste the obtained sub-images together to form an image of said region of interest. Such an image mosaic method is to manually move the positions of the tube and the X-ray detector in parallel. That is, after capturing of each sub-image, the operator shall manually move the tube and the X-ray detector in parallel to the next position based on experience. As a result of manual operation, working efficiency is low, and because different operators have different experience, the finally acquired image of a region of interest is often inaccurate.

U.S. Pat. No. 6,944,265 is similar to U.S. Pat. No. 7,177,455. The disclosed overlap thereof is defined on the sub-image plane, namely the first sub-image and the second sub-image overlapping. Thus, U.S. Pat. No. 6,944,265 also renders the finally acquired image of a region of interest inaccurate, similar to U.S. Pat. No. 7,177,455.

### BRIEF DESCRIPTION OF THE INVENTION

Embodiments of the present invention provide an image acquisition method, device and a radiography system to acquire accurate images.

In one embodiment, an image acquisition method is used for imaging regions of interest of patients by a radiography system. Said radiography system comprises a tube and a detector disposed on opposite positions. The image acquisition method includes a determination step, a calculation step, a capturation step, and a pasting step.

The determination step includes determining the starting position, the ending position of a region of interest, and the value of overlap of the region of interest in the two adjacent sub-images; sub-images.

The calculation step includes calculating the number of the sub-images required to be captured, the component of field of view at the direction of tube movement as well as the positions of the tube and the detector corresponding to each sub-image based on the starting position and the ending position of a region of interest and the value of the overlap.

The capturation step includes moving the tube and the detector to each position and capturing the region of interest to obtain several sub-images at the positions.

The pasting step includes pasting the several sub-images together to form an image of the said region of interest.

In one embodiment, the calculation step also includes calculating a patient coverage on the plane of a region of interest based on the starting position and the ending position of the region of interest.

In one embodiment, the calculation step includes calculating the number of the sub-images required to be captured based on the patient coverage, the distance from the detector incident plane to the plane of the region of interest, the distance from the focus to the detector incident plane and the value of the overlap.

In one embodiment, the calculation step includes calculating the component of the field of view at the direction of the tube movement based on the number of the sub-images required to be captured, the distance from the detector incident plane to the plane of the region of interest, the distance from the focus to the detector incident plane and the value of the overlap.

In one embodiment, the calculation step includes calculating the positions of the tube and the detector corresponding to each sub-image based on the patient coverage, the component of the field of view at the direction of the tube movement, the distance from the detector incident plane to the plane of the region of interest, and the number of said sub-images.

In one embodiment, the pasting step includes cutting off the useless information in the sub-images, determining the search scope as required in the registering of the adjacent images based on the overlap value of the region of interest in the two adjacent sub-images, determining the relative positions matched between the adjacent images from calculating the similarities between the adjacent images based on the search scope, performing image merging on the corresponding pixels of the adjacent images based on the relative positions, and conducting vertical equalization of the merged image.

Additionally, the value of said overlap is preferably from 5 cm to 7 cm.

Accordingly, the image acquisition device of the present invention is used for imaging the regions of interest of patients by a radiography system which comprises a tube and a detector disposed on opposite positions. The image acquisition device includes a determination unit, a calculation unit, a capturation unit, and a pasting unit.

The determination unit determines the starting position and the ending position of a region of interest, and the value of overlap of the region of interest in the two adjacent sub-images.

The calculation unit calculates the number of the sub-images required to be obtained, the component of field of view at the direction of tube movement as well as the positions of the tube and the detector corresponding to each sub-image based on the starting position and the ending position of a region of interest and the value of the overlap.

The capturation unit moves the tube and the detector to each position and controls the tube to capture the region of interest to obtain several sub-images at the positions.

The pasting unit pastes the several sub-images together to form an image of the said region of interest.

The calculation unit includes a first unit for calculating a patient coverage on the plane of a region of interest based on the starting position and the ending position of the region of interest.

The calculation unit also includes a second unit for calculating the number of the sub-images required to be captured based on the patient coverage, the distance from the detector incident plane to the plane of the region of interest, the distance from the focus to the detector incident plane and the value of the overlap.

The calculation unit also includes a third unit for calculating the component of the field of view at the direction of the tube movement based on the number of the sub-images required to be captured, the distance from the detector incident plane to the plane of the region of interest, the distance from the focus to the detector incident plane and the value of the overlap.

The calculation unit also includes a fourth unit for calculating the positions of the tube and the detector corresponding to each sub-image based on the patient coverage, the component of the field of view at the direction of the tube movement, the distance from the detector incident plane to the plane of the region of interest, and the number of said sub-images.

The pasting unit includes a cutting unit for cutting off the useless information in the sub-images, a search scope determining unit for determining the search scope as required in the registering of the adjacent images based on the overlap value of the region of interest in the two adjacent sub-images, a relative position determining unit used for determining the relative positions matched between the adjacent images from calculating the similarities between the adjacent images based on the search scope, a merging unit for performing image merging on the corresponding pixels of the adjacent images based on the relative positions, and a vertical equalization unit for conducting vertical equalization of the merged image.

Furthermore, the value of said overlap is preferably from 5 cm to 7 cm.

Another aspect of the present invention provides an radiography system. The radiography system comprises of a tube and a detector disposed on opposite positions, and further comprises an image acquisition device. The image acquisition device includes a determination unit, a calculation unit, a capturation unit, and a pasting unit.

The determination unit determines the starting position and the ending position of a region of interest, and the value of overlap of the region of interest in the two adjacent sub-images; sub-images.

The calculation unit calculates the number of the sub-images required to be captured, the component of field of view at the direction of tube movement as well as the positions of the tube and the detector corresponding to each sub-image based on the starting position and the ending position of a region of interest and the value of the overlap.

The capturation unit moves the tube and the detector to each position and controls the tube to capture the region of interest to obtain several sub-images at the positions.

The pasting unit pastes the several sub-images together to form an image of the region of interest.

The calculation unit includes a first unit for calculating a patient coverage on the plane of a region of interest based on the starting position and the ending position of the region of interest.

The calculation unit also includes a second unit for calculating the number of the sub-images required to be captured based on the patient coverage, the distance from the detector incident plane to the plane of the region of interest, the distance from the focus to the detector incident plane and the value of the overlap.

The calculation unit also includes a third unit for calculating the component of the field of view at the direction of the tube movement based on the number of the sub-images required to be captured, the distance from the detector incident plane to the plane of the region of interest, the distance from the focus to the detector incident plane and the value of the overlap.

The calculation unit also includes a fourth unit for calculating the positions of the tube and the detector corresponding to each sub-image based on the patient coverage, the component of the field of view at the direction of the tube movement, the distance from the detector incident plane to the plane of the region of interest, and the number of the sub-images.

Firstly, the number of the images required to be captured, the positions of the tube and the detector to be moved to and so on are calculated based on the value of the overlap of the region of interest in the adjacent two images, so each of the resulting adjacent images necessarily has an overlap on the plane of the region of interest, guaranteeing the diagnostic effects and the image pasting quality;

Secondly, it is not necessary for the X-ray tube control device in the present invention to have an electric rotation requirement, so costs can be reduced;

Finally, the present invention uses a mode of determining the starting position and the ending position, and then automatically determining the exposure position, the X-ray field of view, the number of exposures, etc., so the present invention can increase working efficiency and save the operator's time.

### BRIEF DESCRIPTION OF THE DRAWINGS

For a better understanding of the present invention for those skilled in the art, reference is provided to the following detailed description taken in conjunction with the accompanying drawings in which the same reference signs in the drawings refer to the same elements, wherein:

FIG. 1 is a schematic drawing of a known X-ray machine;

FIG. 2 is a schematic drawing of a known method of acquiring an image of a region of interest;

FIG. 3 is a flowchart of an exemplary image acquisition method;

FIG. 4A is a schematic drawing of one example of determining the starting position and the ending position of a region of interest by tube rotation mode;

FIG. 4B is a schematic drawing of one example of determining the starting position and the ending position of a region of interest by tube parallel moving mode;

FIG. 4C is a schematic drawing of the corresponding relationship between an exposure position and a sub-image obtained by using the technical solution of the present invention;

FIG. 5 is a flowchart of the calculation step in FIG. 3;

FIG. 6 is a flowchart of the pasting step in FIG. 3;

FIG. 7 is a schematic drawing of determining the starting position of a patient's region of interest;

FIG. 8 is a schematic drawing of determining the ending position of a patient;

FIG. 9 is a schematic drawing of a first exposure position to which a tube and a detector move after calculation;

FIG. 10 is a schematic drawing of a second exposure position to which the tube and the detector move to;

FIG. 11 is a schematic drawing of a third exposure position to which the tube and the detector move to;

FIG. 12 is a schematic drawing of guaranteeing the fixed overlap of the region of interest by using the technical solution of the present invention;

FIG. 13 shows sub-images acquired by using the present invention and an image obtained by pasting said sub-images;

FIG. 14 is a schematic drawing of an image acquisition device of the present invention.

### DETAILED DESCRIPTION OF THE INVENTION

The following describes the features and advantages and so on of the present invention by exemplary embodiments.

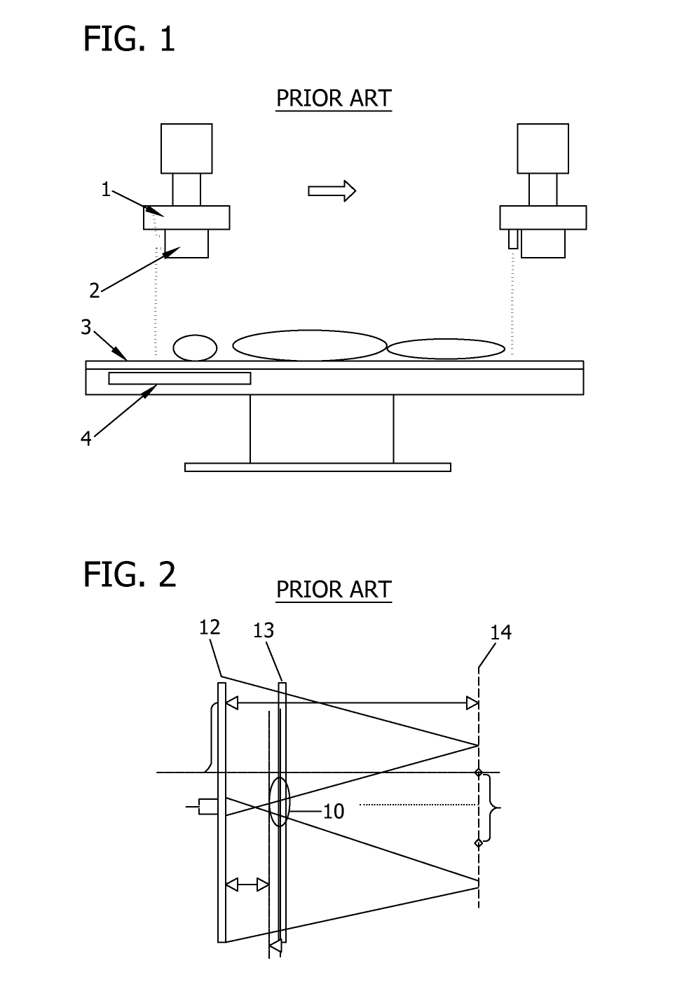

Once more as shown in FIG. 1, said X-ray machine mainly comprises of the X-ray tube 1, the X-ray collimator 2, the patient securing device 3, and the detector 4. The following introduces the technical solution of the present invention on the basis of this X-ray machine.

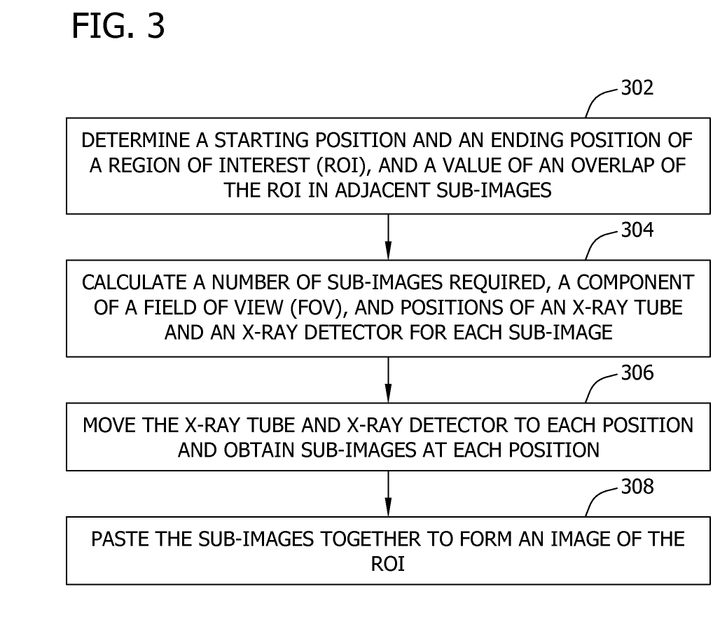

FIG. 3 illustrates a flowchart of the image acquisition method of the present invention. The image acquisition method of the present invention is used for imaging regions of interest of patients by an X-ray based machine. Said x-ray machine comprises the tube 1 (see FIG. 1) and the detector 4 (see FIG. 1) disposed on opposite positions. Said detector 4 is used for receiving X-ray emitted by the tube 1 and generating images. As shown in FIG. 3, the image acquisition method comprises:

1) determination step 302: determining the starting position, the ending position of a region of interest, and the value of overlap of the region of interest in the two adjacent sub-images;

2) calculation step 304: calculating the number of the sub-images required to be captured, the component of field of view at the direction of tube movement as well as the positions of the tube and the detector corresponding to each sub-image based on the starting position and the ending position of a region of interest and the value of said overlap;

3) capturation step 306: moving the tube and the detector to each position and capturing the region of interest to obtain several sub-images at said positions;

4) pasting step 308: pasting the several sub-images together to form an image of the said region of interest.

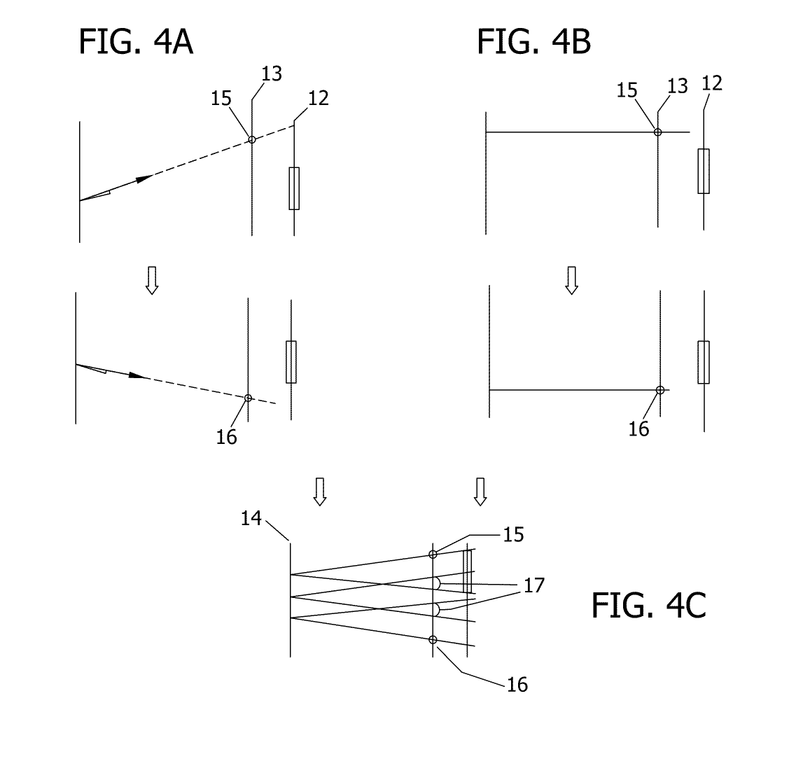

As known from above, the image acquisition method of the present invention firstly determines the starting position and the ending position of a region of interest, and the value of overlap of the region of interest in the two adjacent sub-images. There can be many modes to determine the starting position and the ending position of a region of interest, such as a mode of angulating a tube or a mode of tube parallel moving, as shown in FIG. 4A and FIG. 4B, which are schematic drawings of exemplary embodiments to determine the starting position and the ending position of a region of interest. FIG. 4A is the angulation determination mode and FIG. 4B is the parallel movement determination mode. The angulation determination mode can determine a staring position 15 and an ending position 16 of the region of interest on the plane 13 of the region of interest by rotating the tube 1; the parallel movement determination mode can determine the staring position 15 and the ending position 16 of the region of interest by parallelly moving the tube. Then the number of sub-images required to be captured, the component of the field of view at the direction of tube movement as well as the positions of the tube 1 and the detector 4 corresponding to each sub-image can be calculated based on the starting position 15 and the ending position 16 of the region of interest and the value of said overlap 17. After determining the positions of the tube 1 and the detector 4 for capturing each sub-image, the tube 1 and the detector 4 will be moved to each of the determined positions to capture the region of interest, namely capturing one sub-image in each position, and the number of captured sub-images is equal to the calculated number of sub-images required to be captured. As shown in FIG. 4C, the tube 1 moves along a tube parallel moving plane 14, and the detector 4 moves along a detector incident plane 12, and the corresponding relationship between the exposure positions (positions of tube and detector) and the sub-images required to be captured is indicated; finally these captured sub-images are pasted together to obtain the images of regions of interest.

The technical solution of the image acquisition method of the present invention facilitates creating an overlap of a region of interest in the two adjacent sub-images, rather than just an overlap of the first sub-image and the second sub-image. An overlap of the first sub-image and the second sub-image does not guarantee the overlap of the region of interest in the sub-images, so the images acquired by using sub-image acquisition method of the present invention are more accurate.

The value of said overlap 17 can be 5 cm to 7 cm, or also can be other values. Such an overlap value discovered through a series of experiments can achieve the best balance of the number of exposures and the image quality.

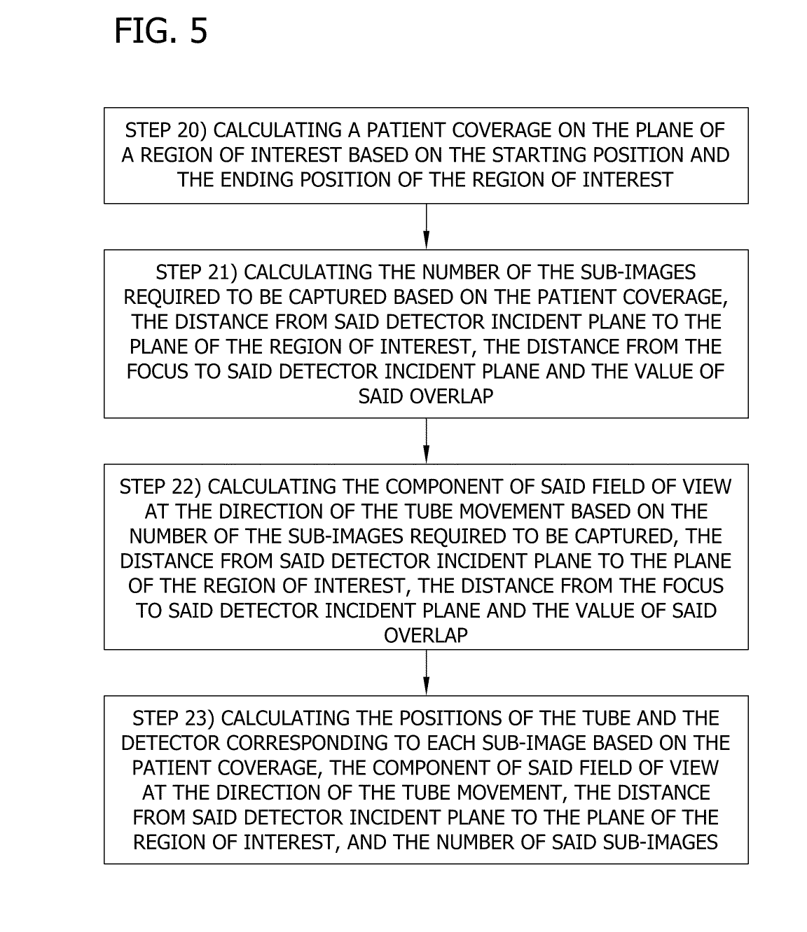

As shown in FIG. 5, said calculation step further comprises:

Step 20) calculating a patient coverage on the plane of a region of interest based on the starting position and the ending position of the region of interest;

Step 21) calculating the number of the sub-images required to be captured based on the patient coverage, the distance from said detector incident plane to the plane of the region of interest, the distance from the focus to said detector incident plane and the value of said overlap;

Step 22) calculating the component of the field of view at the direction of the tube movement based on the number of the sub-images required to be captured, the distance from said detector incident plane to the plane of the region of interest, the distance from the focus to said detector incident plane and the value of said overlap;

Step 23) calculating the positions of the tube and the detector corresponding to each sub-image based on the patient coverage, the component of said field of view at the direction of the tube movement, the distance from said detector incident plane to the plane of the region of interest, and the number of said sub-images.

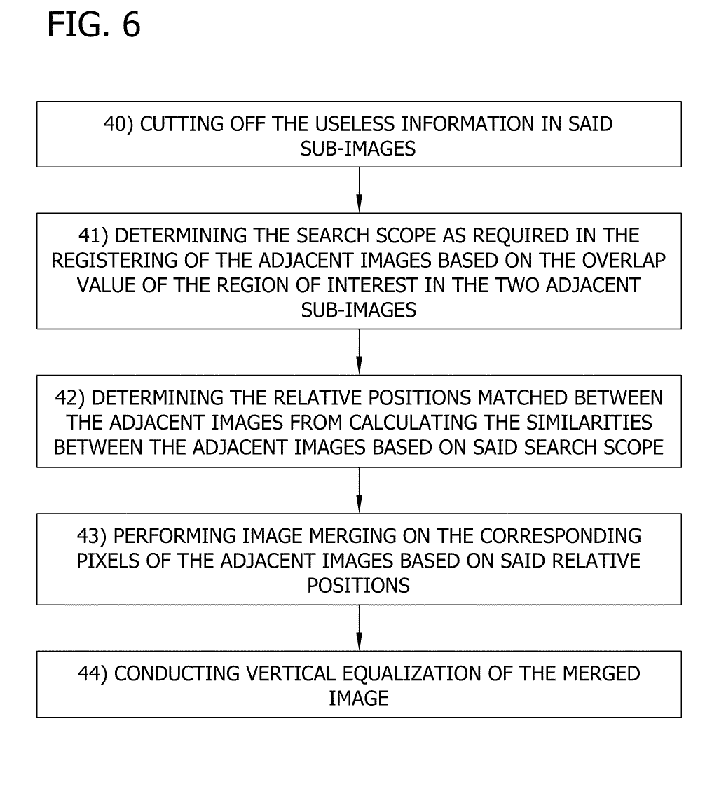

Once more as shown in FIG. 6, said pasting step 4) further comprises:

40) cutting off the useless information in said sub-images;

41) determining the search scope as required in the registering of the adjacent images based on the overlap value of the region of interest in the two adjacent sub-images;

42) determining the relative positions matched between the adjacent images from calculating the similarities between the adjacent images based on said search scope;

43) performing image merging on the corresponding pixels of the adjacent images based on said relative positions;

44) conducting vertical equalization of the merged image.

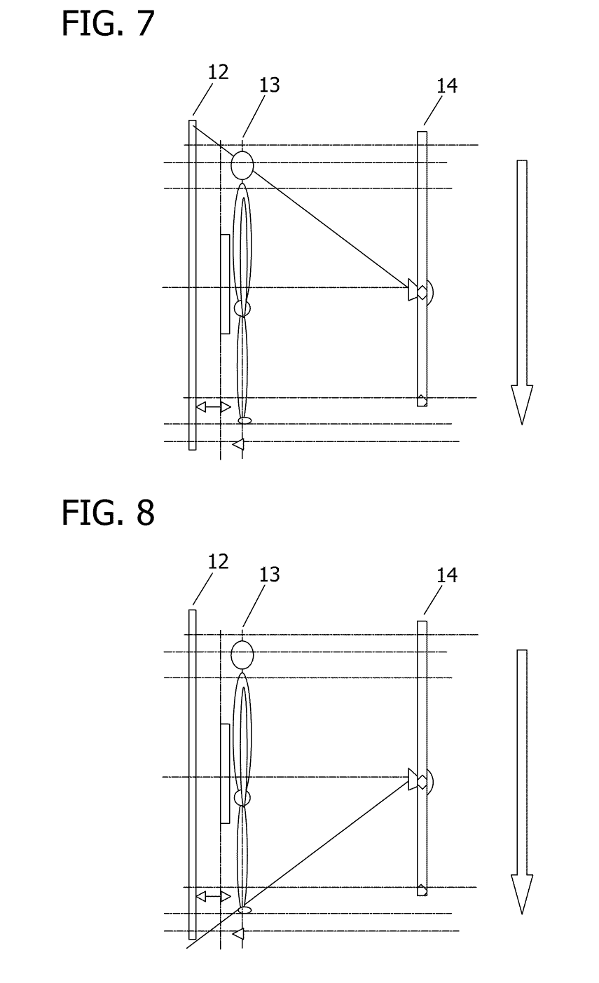

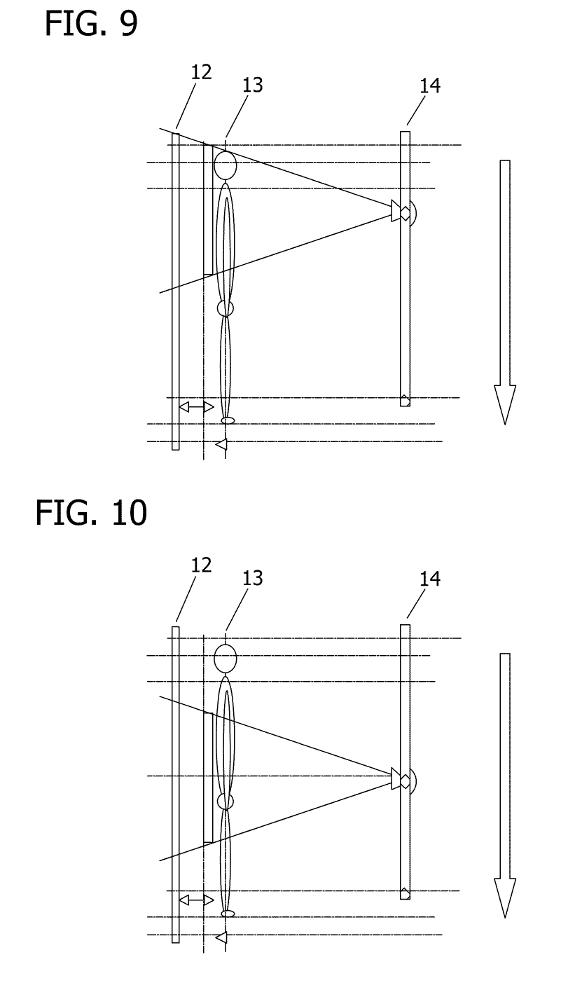

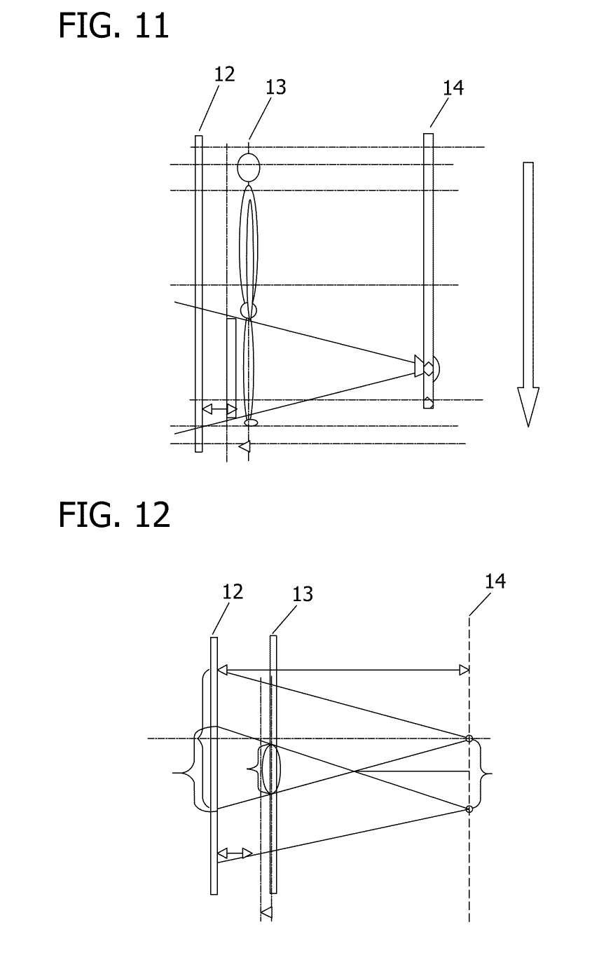

The following describes the technical solution of the image acquisition method of the present invention by an example of acquiring a patient's spine image. As shown in FIGS. 7-12, the tube moves on the tube parallel moving plane 14, and the detector moves on the detector incident plane 12. Firstly, the starting position topMarkedHt of the region of interest is determined to be 1800 mm; the ending position botMarkedHt 1250 mm; the overlap value overlap_anat of the region of interest in the two adjacent sub-images is 50 mm; suppose the system desires the maximum value of FOV (field of view) Hfov_prefer to be 250 mm;

Patient coverage on plane 13 of the region of interest is expressed in Equation (1):

covAnatPlane=topMarkedHt−botMarkedH=550 mm Eq. (1)

Provisional moving distance of the X-ray tube and the detector each time is expressed in Equation (2);

DFS_{—}tmp=Hfov_prefer Hfov_prefer*(detAnatSep/acqSID)overlap_{—}anat Eq. (2)

wherein detAnatSep indicates the distance from the detector incident plane 12 to a plane 13 of the region of interest (constant), acqSID indicates the vertical distance from the tube focus to the detector incident plane 12 (constant).

The number of tube and detector movements is expressed in Equation (3):

N=ceil((covAnatPlane−Hfov_prefer*(acqSID−detAnatSep)/acqSID)/DFS_{—}tmp) Eq. (3)

wherein the function ceil( ) indicates that real number is rounded up to an integer.

The final component of field of view at the direction of tube movement is expressed in Equation (4):

VertColl=(covAnatPlane+overlap_{—}anat*N)/(N+(acqSID−detAnatSep)/acqSID−N*detAnatSep/acqSID) Eq. (4)

The final movement distance of the tube and the detector is:

The overlap value on the detector incident plane 12 is expressed in Equation (6):

overlap=VertColl−DFS Eq. (6)

The final number of exposures is N+1;

The position of the tube and the detector corresponding to each sub-image using Equation (7) where i is from 1 to N+1:

location(i)=topMarkedHt−DFS*(i−1)−(1/2)*((acqSID−COI−detBarrierSep)/acqSID)*VertColl Eq. (7)

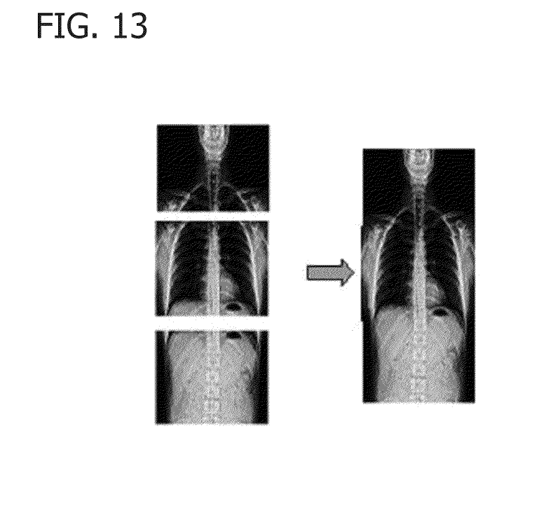

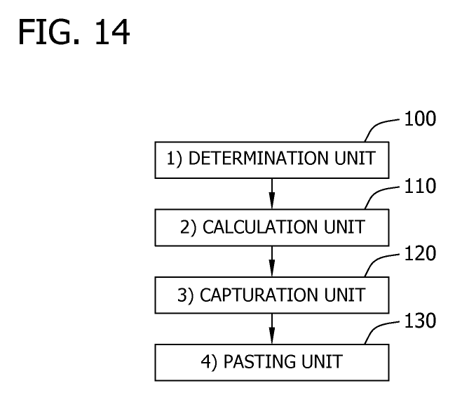

For the present example, because the starting position topMarkedHt of the region of interest is 1800 mm; the ending position botMarkedHt is 1250 mm; the overlap value of the region of interest in the two adjacent sub-images overlap_anat is 50 mm; suppose the system desires a component of field of view at the direction of tube movement to be 250 mm; through the above calculation formula, we firstly obtain the number of the tube and the detector movements is 2, and then the final component of field of view at the direction of tube movement is 243.75 mm; afterwards the obtained final movement distance of the tube and the detector is 166.67 mm; finally the obtained final number of exposures is 3, and the positions of the tube and the detector in each exposure are respectively 1691.67 mm, 1525 mm, 1358.33 mm. Then, moving the tube and the detector to 1691.67 mm, 1525 mm, 1358.33 mm to capture, and as shown in FIG. 13, the left shows the captured three sub-images.

After obtaining the three sub-images, useless information in these sub-images is removed, e.g. the sub-images beyond limitation scope of the collimator 2 (see FIG. 1).

The search scope is determined as required in registering of the adjacent images based on the overlap value on said detector incident plane, which is about 70 mm; the following is to calculate the similarities between the adjacent images based on the search scope so as to determine the relative positions matched between the adjacent images; performing image merging on the corresponding pixels of the adjacent images based on said relative positions; then conducting vertical equalization of the merged image so as to paste the three sub-images into one image, as shown in the right of FIG. 13, wherein said vertical equalization means standardizing each sub-image so that the brightness and contrast and so on of each sub-image are equalized.

To obtain the more accurate images, further processing can be conducted to the images, such as image enhancement methods like tissue equalization, multi-resolution processing, contrast stretching.

Other modes can also be applied for the pasting step, such as methods of mAs SCALING, BLENDING and so on.

For the moving direction of the tube 1, it can be horizontal moving, vertical moving or moving at a certain angle.

Figure is a schematic block diagram of an exemplary image acquisition device.

The image acquisition device includes a determination unit 100 for determining the starting position, the ending position of a region of interest, and the value of overlap of the region of interest in the two adjacent sub-images.

The image acquisition device also includes a calculation unit 110 for calculating the number of the sub-images required to be captured, the component of field of view at the direction of tube movement as well as the positions of the tube and the detector corresponding to each sub-image based on the starting position and the ending position of a region of interest and the value of the overlap.

The image acquisition device also includes a capturation unit 120 for moving the tube and the detector to each of the positions and controlling the tube to capture the region of interest to obtain several sub-images at the positions.

The image acquisition device also includes a pasting unit 130 for pasting the several sub-images together to form an image of the region of interest.

The calculation unit 110 includes a first unit for calculating a patient coverage on the plane of a region of interest based on the starting position and the ending position of the region of interest, and a second unit for calculating the number of the sub-images required to be captured based on the patient coverage, the distance from the detector incident plane to the plane of the region of interest, the distance from the focus to the detector incident plane and the value of the overlap.

The calculation unit 110 also includes a third unit for calculating the component of the field of view at the direction of the tube movement based on the number of the sub-images required to be captured, the distance from the detector incident plane to the plane of the region of interest, the distance from the focus to the detector incident plane and the value of the overlap.

The calculation unit 110 also includes a fourth unit for calculating the positions of the tube and the detector corresponding to each sub-image based on the patient coverage, the component of the field of view at the direction of the tube movement, the distance from the detector incident plane to the plane of the region of interest, and the number of sub-images.

Additionally, the pasting unit 130 includes a cutting unit for cutting off the useless information in the sub-images and a search scope determining unit for determining the search scope as required in the registering of the adjacent images based on the overlap value of the region of interest in the two adjacent sub-images.

The pasting unit 130 also includes a relative position determining unit for determining the relative positions matched between the adjacent images from calculating the similarities between the adjacent images based on the search scope, a merging unit for performing image merging on the corresponding pixels of the adjacent images based on the relative positions, and a vertical equalization unit for conducting vertical equalization of the merged image. The value of said overlap can be 5 cm to 7 cm or other values, preferably 5 cm.

The present invention also discloses a radiography system. The radiography system comprises a tube and a detector disposed on opposite positions, wherein the radiography system further comprises an image acquisition device. The image acquisition device includes a determination unit 100 for determining the starting position, the ending position of a region of interest, and the value of overlap of the region of interest in the two adjacent sub-images, and a calculation unit 110 for calculating the number of the sub-images required to be captured, the component of field of view at the direction of tube movement as well as the positions of the tube and the detector corresponding to each sub-image based on the starting position and the ending position of a region of interest and the value of the overlap.

A capturation unit 120 moves the tube and the detector to each position and controlling the tube to capture the region of interest to obtain several sub-images at the positions.

A pasting unit 130 pastes the several sub-images together to form an image of the region of interest.

The calculation unit 110 includes a first unit for calculating a patient coverage on the plane of a region of interest based on the starting position and the ending position of the region of interest, and a second unit for calculating the number of the sub-images required to be captured based on the patient coverage, the distance from the detector incident plane to the plane of the region of interest, the distance from the focus to the detector incident plane and the value of the overlap.

The calculation unit 110 also includes a third unit, for calculating the component of the field of view at the direction of the tube movement based on the number of the sub-images required to be captured, the distance from the detector incident plane to the plane of the region of interest, the distance from the focus to the detector incident plane and the value of the overlap.

The calculation unit 110 also includes a fourth unit, for calculating the positions of the tube and the detector corresponding to each sub-image based on the patient coverage, the component of the field of view at the direction of the tube movement, the distance from the detector incident plane to the plane of the region of interest, and the number of sub-images.

Additionally, the pasting unit 130 includes a cutting unit for removing the useless information in the sub-images, and a search scope determining unit for determining the search scope as required in the registering of the adjacent images based on the overlap value of the region of interest in the two adjacent sub-images.

The pasting unit 130 also includes a relative position determining unit, for determining the relative positions matched between the adjacent images from calculating the similarities between the adjacent images based on the search scope, a merging unit for performing image merging on the corresponding pixels of the adjacent images based on the relative positions, and a vertical equalization unit for conducting vertical equalization of the merged image.

To sum up, firstly, the number of the images required to be captured, the positions of the tube and the detector to be moved to and so on are calculated based on the value of the overlap of the region of interest in the adjacent two images, so each of the resulting adjacent images necessarily has an overlap on the plane of the region of interest, guaranteeing the diagnostic effects and the image pasting quality;

Secondly, it is not necessary for the X-ray tube control device in the present invention to have an electric rotation requirement, so costs can be reduced;

Finally, the present invention uses a mode of determining the starting position and the ending position, and then automatically determining the exposure position, the X-ray field of view, the number of exposures, etc., so the present invention can increase working efficiency and save the operator's time.

The features of the invention have been described with reference to various specific examples. However, it should be understood that many variations and modifications may be made by those skilled in the art without departing from the spirit and scope of the invention. All such modifications and changes are intended to be included in the scopes that are defined by the accompanying claims.

1. An image acquisition method for imaging regions of interest of patients by a radiography system that includes a tube and a detector disposed on opposite positions, said image acquisition method comprising:
determining starting and an ending position of a region of interest, and a value of an overlap of the region of interest in two adjacent sub-images;
calculating a number of sub-images required to be captured, a component of field of view at a direction of tube movement, and positions of the tube and the detector corresponding to each sub-image based on the starting position and the ending position of the region of interest and the value of the overlap;
moving the tube and the detector to each position and capturing the region of interest to obtain sub-images at the positions; and
pasting the sub-images together to form an image of the region of interest.

2. The image acquisition method according to claim 1, wherein calculating comprises:
calculating a patient coverage on a plane of the region of interest based on the starting position and the ending position of the region of interest;
calculating the number of the sub-images required to be captured based on the patient coverage, a distance from the detector incident plane to a plane of the region of interest, a distance from a focus to the detector incident plane, and the value of the overlap;
calculating a component of the field of view at the direction of the tube movement based on the number of the sub-images required to be captured, the distance from the detector incident plane to the plane of the region of interest, the distance from the focus to the detector incident plane and the value of the overlap; and
calculating the positions of the tube and the detector corresponding to each sub-image based on the patient coverage, the component of the field of view at the direction of the tube movement, the distance from the detector incident plane to the plane of the region of interest, and the number of sub-images.

3. The image acquisition method according to claim 2, wherein pasting comprises:
removing at least a portion of information in the sub-images;
determining a search scope as required in registering of the adjacent images sub-images based on the overlap value of the region of interest in the two adjacent sub-images;
determining relative positions matched between the adjacent sub-images by calculating similarities between the adjacent sub-images based on the search scope;
performing image merging on corresponding pixels of the adjacent sub-images based on the relative positions; and
conducting vertical equalization of the merged image.

4. The image acquisition method according to claim 1, wherein the value of the overlap is from 5 cm to 7 cm.

5. An image acquisition device for imaging regions of interest of patients with a radiography system that includes a tube and a detector disposed on opposite positions, said image acquisition device comprises:
a determination unit configured to determine a starting and an ending position of a region of interest, and a value of an overlap of the region of interest in two adjacent sub-images;
a calculation unit configured to calculate a number of sub-images required to be obtained, a component of field of view at a direction of tube movement as well as a plurality of positions of the tube and the detector corresponding to each sub-image based on the starting position and the ending position of the region of interest and the value of the overlap;
a capturation unit configured to move the tube and the detector to each position and to capture the region of interest to obtain sub-images at the plurality of positions; and
a pasting unit configured to paste the sub-images together to form an image of the region of interest.

6. The image acquisition device according to claim 5, wherein said calculation unit comprises:
a first unit configured to calculate a patient coverage on a plane of the region of interest based on the starting position and the ending position of the region of interest;
a second unit configured to calculate the number of sub-images required to be captured based on the patient coverage, a distance from a detector incident plane to a plane of the region of interest, a distance from a focus to the detector incident plane and the value of the overlap;
a third unit configured to calculate a component of the field of view at the direction of the tube movement based on the number of sub-images required to be captured, the distance from the detector incident plane to the plane of the region of interest, the distance from the focus to the detector incident plane and the value of the overlap; and
a fourth unit configured to calculate the plurality of positions of the tube and the detector corresponding to each sub-image based on the patient coverage, the component of the field of view at the direction of the tube movement, the distance from the detector incident plane to the plane of the region of interest, and the number of sub-images.

7. The image acquisition device according to claim 6, wherein said pasting unit further comprises:
a cutting unit configured to remove at least a portion of information in the sub-images;
a search scope determining unit configured to determine a search scope as required in registering of the adjacent sub-images based on the overlap value of the region of interest in the two adjacent sub-images;
a relative position determining unit configured to determine relative positions matched between the adjacent sub-images from calculating similarities between the adjacent sub-images based on the search scope;
a merging unit configured to perform image merging on corresponding pixels of the adjacent sub-images based on the relative positions; and
a vertical equalization unit configured to conduct vertical equalization of the merged image.

8. The image acquisition device according to claim 5, wherein the value of the overlap is from 5 cm to 7 cm.

9. A radiography system, said radiography system comprises system comprising:
a tube and a detector disposed on opposite positions; and
an image acquisition device comprising:
a determination unit configured to determine a starting and an ending position of a region of interest, and a value of an overlap of the region of interest in two adjacent sub-images;
a calculation unit configured to calculate a number of sub-images required to be obtained, a component of field of view at a direction of tube movement as well as a plurality of positions of the tube and the detector corresponding to each sub-image based on the starting position and the ending position of the region of interest and the value of the overlap;
a capturation unit configured to move the tube and the detector to each position and to capture the region of interest to obtain sub-images at the plurality of positions; and
a pasting unit configured to paste the sub-images together to form an image of the region of interest.

10. The radiography system according to claim 9, wherein said calculation unit comprises:
a first unit configured to calculate a patient coverage on a plane of the region of interest based on the starting position and the ending position of the region of interest;
a second unit configured to calculate the number of sub-images required to be captured based on the patient coverage, a distance from a detector incident plane to a plane of the region of interest, a distance from a focus to the detector incident plane and the value of the overlap;
a third unit configured to calculate a component of the field of view at the direction of the tube movement based on the number of sub-images required to be captured, the distance from the detector incident plane to the plane of the region of interest, the distance from the focus to the detector incident plane and the value of the overlap; and
a fourth unit configured to calculate the plurality of positions of the tube and the detector corresponding to each sub-image based on the patient coverage, the component of the field of view at the direction of the tube movement, the distance from the detector incident plane to the plane of the region of interest, and the number of sub-images.

11. The radiography system according to claim 10, wherein said pasting unit comprises:
a cutting unit configured to remove at least a portion of information in the sub-images;
a search scope determining unit configured to determine a search scope as required in registering of the adjacent sub-images based on the overlap value of the region of interest in the two adjacent sub-images;
a relative position determining unit configured to determine relative positions matched between the adjacent sub-images from calculating similarities between the adjacent sub-images based on the search scope;
a merging unit configured to perform image merging on corresponding pixels of the adjacent sub-images based on the relative positions; and
a vertical equalization unit configured to conduct vertical equalization of the merged image.

12. The image acquisition method according to claim 2, wherein the value of the overlap is from 5 cm to 7 cm.

13. The image acquisition method according to claim 3, wherein the value of the overlap is from 5 cm to 7 cm.

14. The image acquisition device according to claim 6, wherein the value of the overlap is from 5 cm to 7 cm.

15. The image acquisition device according to claim 7, wherein the value of the overlap is from 5 cm to 7 cm.

16. The image acquisition device according to claim 6, wherein said capturation device is configured to move the tube along a tube moving plane that is substantially parallel to the detection incident plane.

17. The radiography system according to claim 9, wherein the value of the overlap is from 5 cm to 7 cm.

18. The radiography system according to claim 10, wherein the value of the overlap is from 5 cm to 7 cm.

19. The radiography system according to claim 11, wherein the value of the overlap is from 5 cm to 7 cm.

20. The radiography system according to claim 10, wherein said capturation device is configured to move said tube along a tube moving plane that is substantially parallel to the detection incident plane.
